(19) United States
(12) Patent Application Publication
(10) Pub. No.: US 2014/0047797 A1
(43) Pub. Date: Feb. 20, 2014

(54) Method for filling a container with a liquid

(71) Applicant: Benedikt Leibinger, Freiburg (DE)

(72) Inventor: Benedikt Leibinger, Freiburg (DE)

(73) Assignee: LEIBINGER GMBH, Teningen (DE)

(21) Appl. No.: 14/113,427

(22) PCT Filed: Mar. 22, 2012
(86) PCT No.: PCT/DE12/00309

§ 371 Date: Oct. 23, 2013

(30) Foreign Application Priority Data
May 5, 2011 (DE) 10 2011 100 560.2

(51) Int. Cl. B67C 3/02

(52) U.S. Cl. CPC B67C 3/02
USPC 53/284.5

(57) ABSTRACT

The invention relates to a method for filling a container (1) filled with liquid (7), comprising a balloon-like body (6) that is introduced into the container (1). An expansion medium (8) is introduced into said balloon-like body (6), such that the balloon-like body (6) is inflated. Subsequently, the balloon-like body (6) is re-emptied, such that the liquid (7) to be introduced is drawn in.

The invention concerns a method for filling a container with a liquid that is in particular designed for consumption.

For filling a container, in particular a bottle, with a liquid that is designed for consumption, in particular a beverage, this liquid is fed into the container, for example, by means of a supply tube. The problem in this connection is that the liquid is exposed to ambient air with the result of undesirable gas release, gas exchange, or gas introduction.

Based on this, it is the object of the invention to develop a method for filling a container with a liquid that is in particular designed for consumption without the liquid coming into contact with the gas contained in the bottle.

The technical solution is characterized by the features in the characterizing portion of claim 1.

In this way, an effective method is provided for filling, without gas contact, a container with a liquid that is designed in particular for consumption. The method is characterized in that the liquid during the filling process does not come into contact with a gas, for example, air or another gas. The advantage of this method resides thus in that the liquid, while the container is being filled, is not subjected to any gas release, gas exchange, or gas introduction. Performing the method provides that into the container first at least one balloon-type body is inserted. In the initial state, the latter can be of any shape. Since this balloon-type body after insertion into the container is filled by means of a medium, the interior of the container is completely filled in this way. For filling the balloon-type body with the expansion medium there are two possibilities. On the one hand, the expansion medium can be fed with overpressure into the balloon-type body so that it is inflated in this way. On the other hand, the intermediate space between the balloon-type body and the inner wall of the container can be subjected to underpressure so that, as a result of the pressure difference that is generated in this way, the balloon-type body will suck in the expansion medium and is thereby inflated. After filling of the balloon-type body with the expansion medium, the expansion medium escapes again from this balloon-type body. For improving the effect, the expansion medium can be sucked away additionally. In the container a space is formed between the balloon-type body and the inner wall of the container into which the liquid is supplied so that the container is filled with this liquid. This is enhanced when the escape of the expansion medium causes an underpressure which sucks in the liquid to be filled in. A further enhancement is provided when the liquid with respect to the expansion medium has an overpressure and is thus supplied to the container with overpressure. Finally, by throttling the escape of the expansion medium, a counter pressure can be maintained that suppresses the release of, for example, CO₂, during inflow of the liquid into the container. Since the balloon-type body is liquid-tight as well as gas-tight, the expansion medium which is contained in this balloon-type body cannot come into contact with the liquid. After complete filling of the container, the balloon-type body is then removed again from the container and is ready for the next filling process.

The embodiment according to claim 2 proposes that the balloon-type body is expandable. This means that this balloon-type body upon filling in the medium will expand like an air-filled balloon and, in reverse, will return into its initial shape upon escape or upon pumping away the medium. When the expandable balloon-type body is filled with air, for example, and, subsequently, for filling the container with the liquid, the air supply of the now full balloon-type body is opened again, the air will escape automatically from the balloon-type body in the same way as air escapes from an air-filled balloon. This is so because the balloon-type body contracts as a result of its flexibility and forces out the air contained therein. This effect is enhanced when the liquid has an overpressure relative to the expansion medium (this is so because only the pressure difference of liquid pressure to the expansion medium pressure plus “restoring force” of the balloon-type body is important). The balloon-type body has the advantage that upon introduction into the container it has only a very minimal volume so that the insertion process can be performed without problems.

Alternatively, in accordance with claim 3, it is also conceivable that the balloon-type body is not expandable.

A preferred embodiment according to claim 4 proposes that the balloon-type body can be inflated in a targeted fashion and, most importantly, can be emptied again and this in such a way that all liquid to be filled into the container can be supplied without problem to the container. Technically, this can be realized in that the balloon-type body is appropriately profiled, i.e., when the expansion medium is emptied from it, the profile first is emptied in the area of the container opening and then, successively, moves to the container bottom. Alternatively, it is also possible that several balloon-type bodies are provided, for example, a first balloon-type body in the bottom area of the container, a second balloon-type body in the center area of the container, as well as finally a third balloon-type body in the area of the container opening. They are inflated as well as, most importantly, emptied sequentially during the filling process with the liquid.

In a further preferred embodiment according to claim 5, it is proposed that the at least one balloon-type body has correlated therewith an elongate support with which the balloon-type body is inserted into the container. This elongate support is to be understood in a general sense. Basically, this support is an elongate narrow structure which can be inserted without problem together with the balloon-type body through the opening of the container into this container. In reverse, the constructive unit of elongate support and balloon-type body can be removed from the container without problem once filling with the liquid is terminated.

A variant embodiment thereof proposes according to claim 6 that the support is arranged in a cap. This means that, after introduction of the support into the container, this cap is resting on the container opening and therefore provides a liquid-tight closure with the container opening for the filling process.

Preferably, the above-described cap has, according to the embodiment of claim 7, an opening through which the liquid can be supplied.

The embodiment according to claim 8 proposes a first variant of the support in the form of a tube. The basic principle resides in that the balloon-type body or bodies is/are arranged on a tube wherein the balloon-type body envelopes this tube. When then through the tube the balloon-type body is supplied with an the expansion medium, the balloon-type body is inflated about the tube. For this purpose, the tube, in accordance with the number of balloon-type bodies, is provided with appropriate openings for outflow of the expansion medium. The use of a tube has the advantage that it can be introduced together with the balloon-type body in a very simple way into the container.

The embodiment according to claim 9 proposes a second variant of the support in the form of one or several rods on which the balloon-type body is resting. Basically, it is also possible in this context that the two variants tube/rod are combined. The rod is to be understood in the most general sense. It is an elongate structure. In contrast to the afore described tube, however, this rod is not in the interior of the balloon-type body but the rod and the balloon-type body are positioned adjacent to each other. The advantage of this rod is, on the one hand, that the balloon-type body can be introduced into the container in a simple way because the rod and the balloon-type body together form essentially a constructive unit. On the other hand, the rod has the advantage that, upon gradual inflation of the balloon-type body, it is positioned between the exterior envelope of this balloon-type body and the inner wall of the container. In this way, a small gap between the outer envelope of the balloon-type body and the inner wall of the container is automatically provided through which air can escape toward the container opening. The advantage is thus that even after complete inflation of the balloon-type body no air pockets can form within the container. The air of these air pockets can escape through the afore described gap without a problem from the container opening.

The embodiment according to claim 10 proposes various configurations of the rod. On the one hand, it can be flexible so that it automatically will adjust to the respective contours. However, the rod can also be relatively rigid. In this case, it is shaped such that it is matched to the inner contour of the container.

Moreover, the embodiment according to claim 11 proposes that the leading end of the at least one rod is connected to the leading end of the balloon-type body. For this purpose, a plastic string or the like can be provided. The advantage is that in the initial position the balloon-type body, by fixation at the leading end of the rod, has assumed an extended initial position and, therefore, can be inserted without problem through the container opening into the container. A further advantage resides in that a possibly remaining air pocket in the bottom area of the container is forced to escape toward the support.

The embodiment according to claim 12 proposes that the outer surface of the balloon-type body has raised portions, in particular knob-shaped raised portions. Between these raised portions, a gap for escape of air can be formed. In this way, it is possible, as already disclosed in connection with the rod, that automatically a gap between the exterior envelope of the balloon-type body and the inner wall of the container can be generated through which air can escape toward the container opening. The advantage resides thus again in that, even after complete inflation of the balloon-type body, no air bubbles can form in the container. The air of these air pockets can escape without problem via the afore described gap through the container opening. The knob-shaped raised portions can be, for example, designed in a diamond shape.

According to the embodiment of claim 13, as a medium for filling the balloon-type body or bodies, a gas, in particular air, or a liquid, in particular water, can be used.

Embodiments of a filling device according to the invention for filling a container with a liquid designed for consumption will be to described in the following with the aid of the drawings. It is shown in:

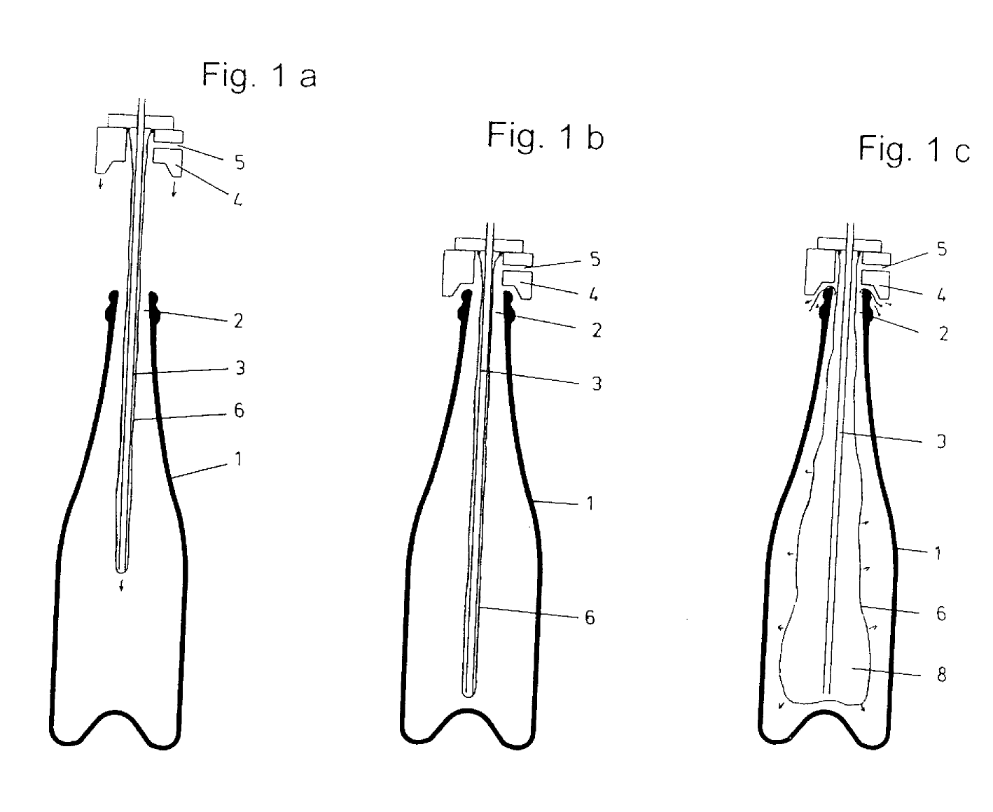

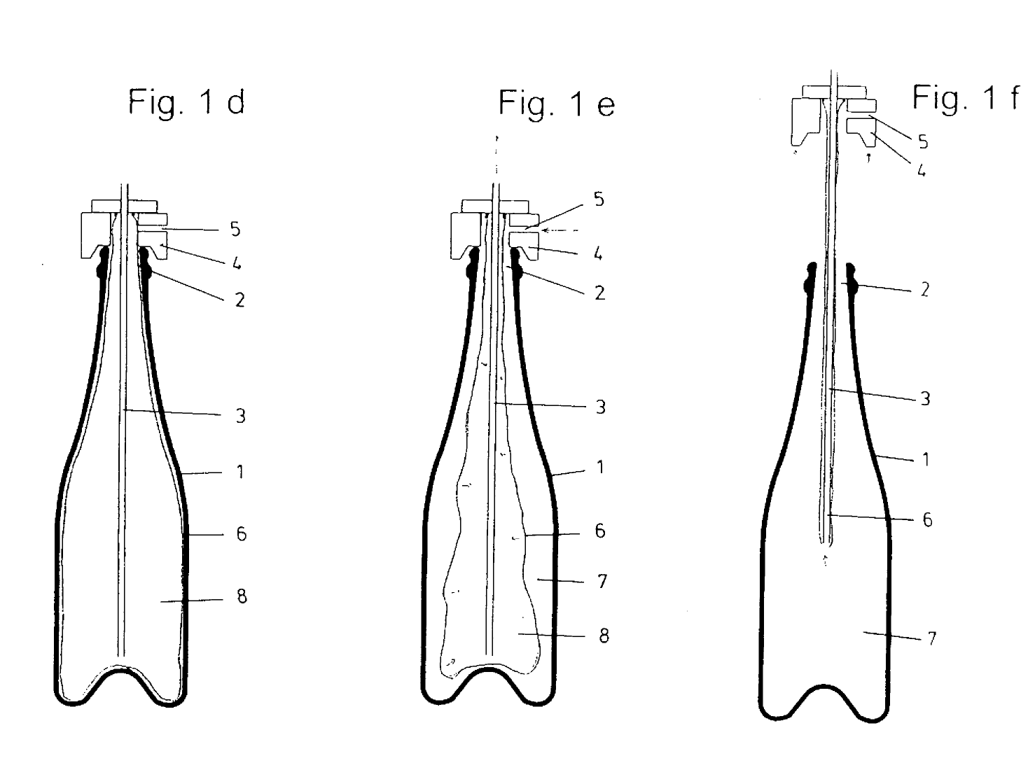

FIGS. 1a to 1g a first embodiment wherein various method stages are illustrated;

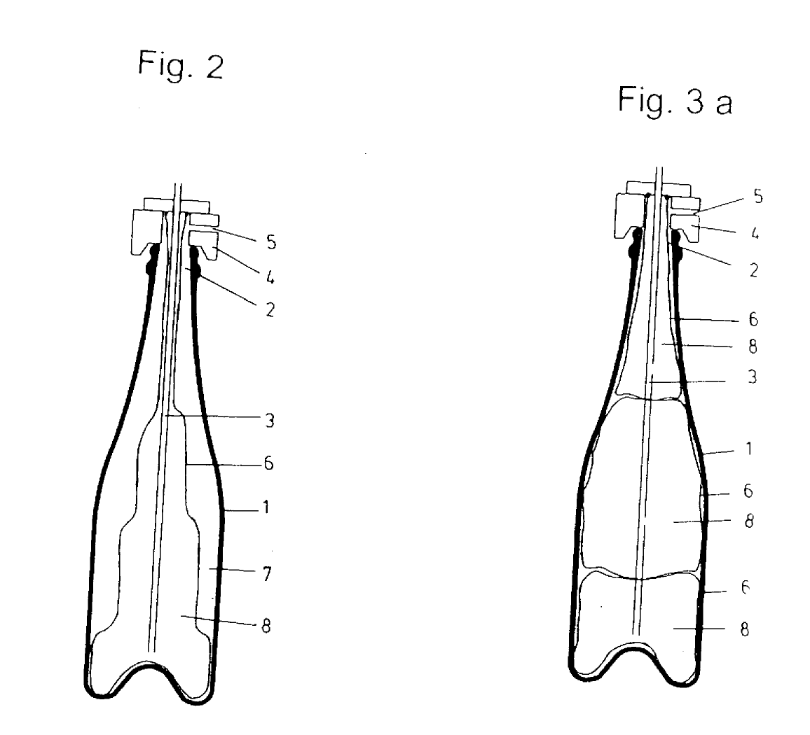

FIG. 2 a second embodiment of the device;

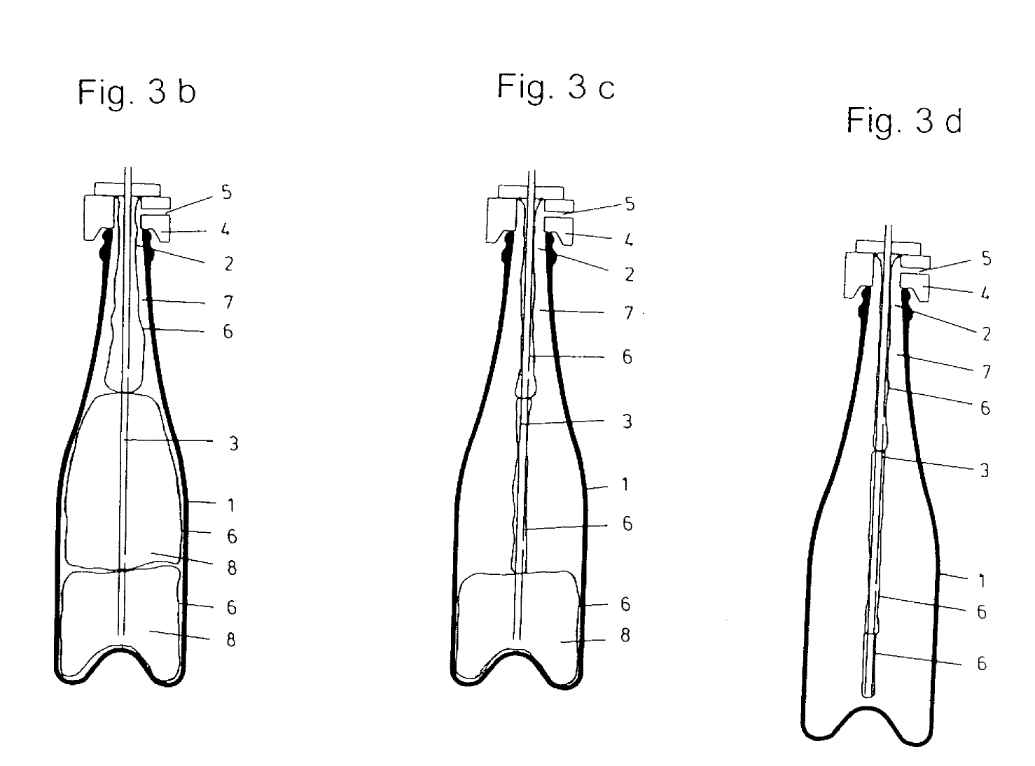

FIGS. 3a to 3d a third embodiment of the device using three balloon-type bodies, also in various method stages;

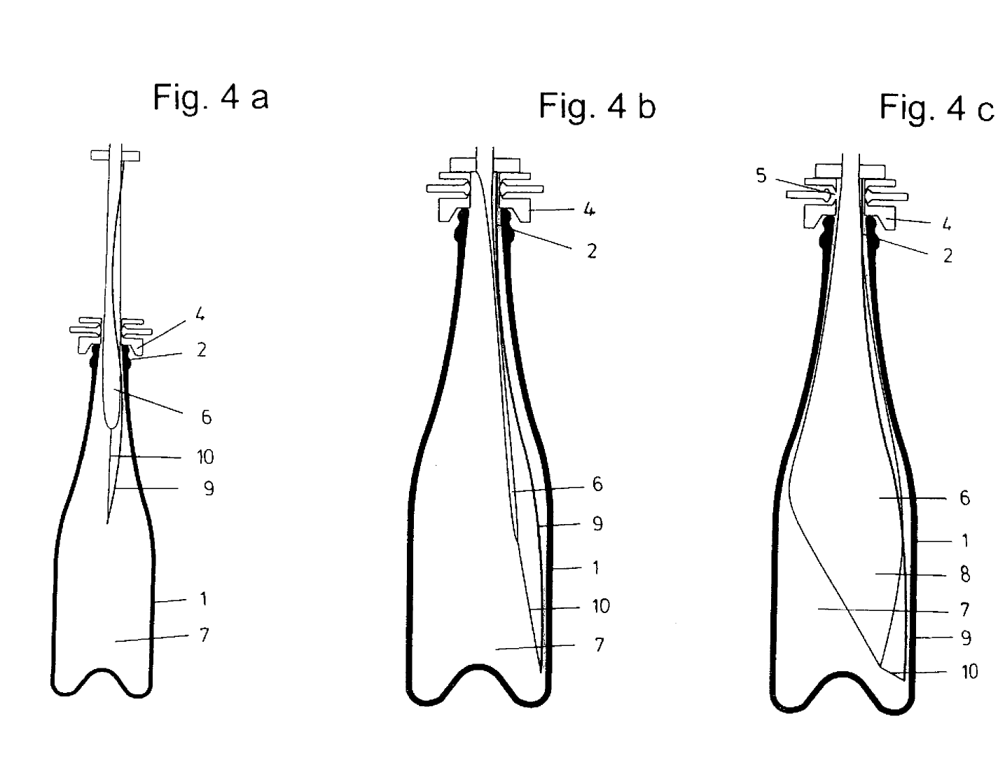

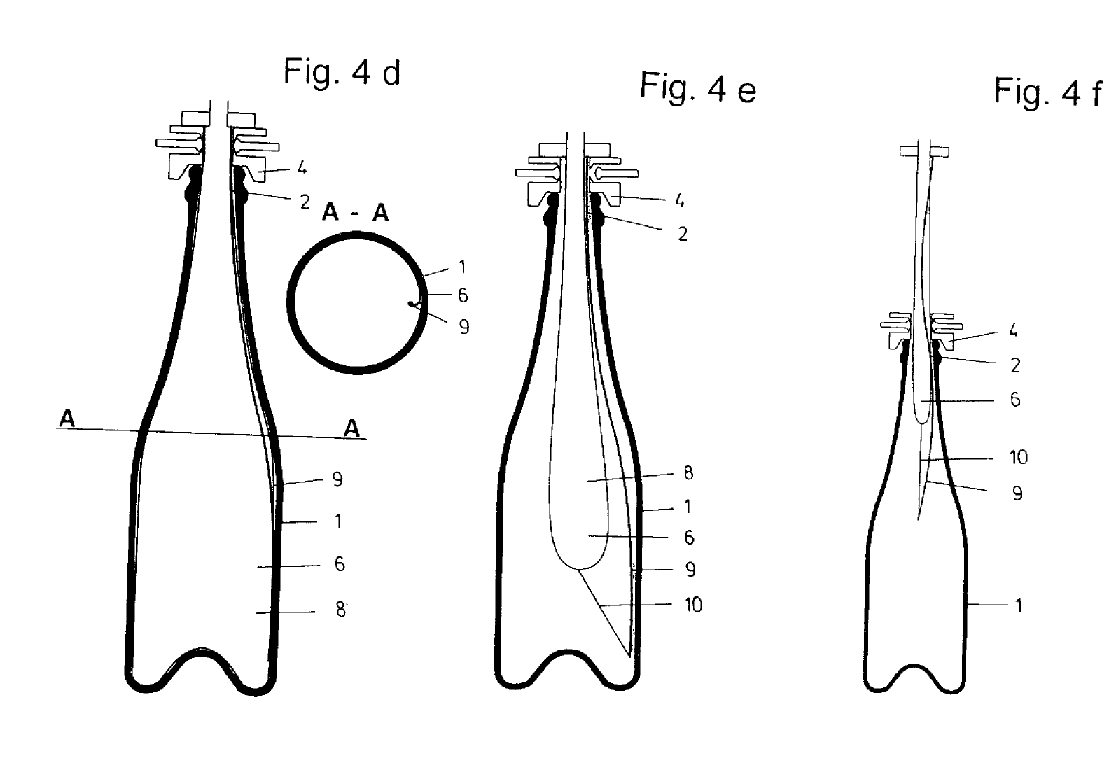

FIGS. 4a to 4g a fourth embodiment wherein various method stages are illustrated.

FIG. 1a of the first embodiment of the filling device shows a container 1 in the form of a bottle with a container opening 2. The filling device is comprised firstly of a tube 3 that is mounted in a cap 4. This tube 3 is open at the bottom end. Moreover, it has at the top a feed opening for a medium. The cap 4 has finally also a lateral opening 5.

Onto the tube 3, a flexible body 6 is pushed and is attached with its upper circumferential rim seal-tightly on the cap 4. This body 6 can be inflated to a balloon of sorts.

The function is as follows.

The filling device is inserted with the tube 3 leading into the container 1 through the container opening 2. FIG. 1b shows the situation with the filling device completely inserted and the cap 4 in this situation located somewhat spaced above the container opening 2, i.e., not seal-tightly attached.

FIG. 1c shows how an expansion medium 8, in particular air (but also alternatively a hydraulic expansion medium) is fed to the tube 3. This expansion medium 8 exits from the lower opening of the tube 3 and inflates thereby gradually the body 6 to a balloon-type body 6. The air that is contained in the container 1 escapes in this context through the ring-shaped intermediate gap between the container opening 2 and the cap 4. The final situation is shown in FIG. 1d. It shows how the balloon-shaped body 6 is completely contacting the inner wall of the container 1. Also, the cap 4 now has been seal-tightly placed onto the container 1.

There are two possibilities for filling the balloon-type body 6 with the expansion medium 8.

On the one hand, the expansion medium 8 can be supplied with overpressure to the balloon-type body 6 so that the latter is inflated in this way.

On the other hand, underpressure can be applied to the intermediate space between the balloon-type body 6 and the inner wall of the container 1 so that, as a result of the produced pressure difference, the balloon-type body 6 will suck in the expansion medium 8 and be inflated in this way.

As illustrated in FIG. 1e, the expansion medium 8 subsequently will escape again. By throttling the escaping expansion medium 8, a counter pressure is maintained that suppresses the release of, for example, CO₂ during inflow of the liquid 7 into the container 1. Because of its elasticity, the balloon-type body 6 contracts. Through the opening 5 in the cap 4, the liquid 7 is supplied to the container 1. The liquid 7 displaces the balloon-type body 6 with the required volume. The intermediate space between the balloon-type body 6 and the inner wall of the container 1 depends on the quantity of the supplied liquid 7.

After complete filling of the container 1, the filling device is pulled out of the container 1 again (FIG. 1f).

FIG. 2 shows a somewhat modified embodiment of the balloon-type body 6. Here it is shown that the balloon-type body 6 upon filling in the expansion medium 8 will inflate in a profiled way such that first the bottom area of the container 1 is filled out, subsequently the central container area, and finally the neck area of the container 1. Emptying of the balloon-type body 6 for the filling process is then realized in reverse order.

FIGS. 3a to 3d show a further modified embodiment of the filling device. A total of three balloon-type bodies 6 are provided that are secured on top of each and arranged so as to envelope the tube 3. Each of these three balloon-type bodies 6 has associated therewith an exit opening of the tube 3.

In this embodiment, first the lowermost balloon-shaped body 6 is inflated (FIG. 3b), subsequently the central balloon-type body 6 (FIG. 3c) as well as finally the uppermost balloon-shaped body 6 (FIG. 3d). Emptying of the balloon-type body 6 for the filling process is done in reverse order.

FIGS. 4a to 4d show a further modified embodiment of the filling device. Here, the basic principle resides in that a rod 9 is arranged on the cap 4 instead of a tube 3. This rod 9 is comprised in particular of plastic material and is formed as an elongate flexible structure. In contrast to the tube 3, the rod 9 does not extend into the balloon-type body 6 but the balloon-type body 6 and the rod 9 are instead positioned side-by-side. The leading end of the balloon-type body 6 is connected with the leading end of the rod 9 by a string 10 or the like.

Moreover, in FIGS. 4b to 4e it can be seen that the upper end of the balloon-type body 6 in the area of the valve opening of the cap 4 is resting directly on the inner wall of the axial through bore that is formed in this cap 4. This has the advantage that no air gap remains with which the liquid 7 might come into contact. This configuration is also usable in connection with the afore described embodiments.

The basic principle of filling corresponds to the basic principle as already disclosed above. This means that the rod 9 with its balloon-type body 6 is inserted into the container opening 2 of the container 1 (FIGS. 4a and 4b). After opening a valve, the balloon-type body 6 is filled with air so that, as a result of the associated displacement effect, the air that is contained in the container 1 is pressed out and thus escapes through an outlet valve (FIGS. 4c and 4d). Likewise, it is also possible to apply a vacuum to the container 1 so that the balloon-type body 6 is filled with air as a result of the pressure difference.

Subsequently, the air is then released again from the balloon-type body 6. Since the balloon-type body 6 is similar to an air-filled balloon of sorts, upon release of the air the latter will contract automatically and therefore will force out the air contained in the balloon-type body 6 (FIG. 4e). At the same time, the liquid 7 is sucked into the container 1 or the liquid 7 is supplied under pressure. Subsequently, the filling device can be removed again from the container 1 and can be used for a subsequent filling process (FIG. 4f).

The advantage in using the afore described rod 9 is that the latter, upon filling the balloon-type body 6 with air, is positioned between the outer wall surface of this balloon-type body 6 and the inner wall surface of the container 1 in such a way that along the rod 9 a gap is formed. In this way, a possibility is provided that all air can escape from the container inasmuch as any air pockets should form in case the balloon-type body 6 inflates in an unfavorable way. This is illustrated in the section illustration of FIG. 4d. The gap will be reduced automatically with increasing inflation of the balloon-type body 6. The air gap essentially ensures by itself that it is minimized or eliminated.

### LIST OF REFERENCE CHARACTERS

1 container

2 container opening

3 tube

4 cap

5 opening

6 balloon-type body

7 liquid

8 expansion medium

9 rod

10 string

What is claimed is:

1.-13. (canceled)

14. A device for filling a container in the form of a bottle with a liquid, the device comprising:
a cap adapted to be fitted fluid-tightly on a container opening of a container to be filled, wherein the cap has a lateral opening for supplying the liquid to the container;
at least one balloon body that is liquid-tight relative to the liquid and gas-tight, wherein the at least one balloon body is adapted to be filled or inflated with an expansion medium from an initial state of the balloon body to a filled or inflated state of the balloon body;
wherein the at least one balloon body has an upper circumferential rim that is attached seal-tightly to the cap, wherein the lateral opening opens laterally at an exterior side of the balloon body;
an elongate support associated with the at least one balloon body and arranged at the cap;
wherein, for filling the container, first the elongate support together with the at least one balloon body is inserted into the container;
wherein subsequently the at least one balloon body is filled or inflated with the expansion medium so that the at least one balloon body in the filled or inflated state fills out an interior of the container;
wherein the expansion medium subsequently is allowed to escape from the balloon body so that an intermediate space between the balloon body and the container is formed and the liquid to be filled in is supplied through the lateral opening into the intermediate space.

15. The device according to claim 14, wherein the at least one balloon body upon supply of the expansion medium expands and after escape of the expansion medium returns into the initial state.

16. The device according to claim 14, wherein the at least one balloon body is non-expandable.

17. The device according to claim 14, wherein the expansion medium can be emptied from the at least one balloon body such that the interior of the container is successively filled with the liquid from the container opening toward the end of the container remote from the container opening.

18. The device according to claim 14, wherein the elongate support is a tube on which the at least one balloon body is arranged liquid-tightly and gas-tightly, wherein the at least one balloon body envelopes the tube at least partially and rests on the tube in the initial state, wherein the tube has at least one exit opening for the expansion medium and the expansion medium supplied to the tube enters the balloon body through the exit opening to inflate the balloon body and the expansion medium escapes from the balloon body though the exit opening.

19. The device according to claim 14, wherein the elongate support is at least one rod on which the balloon body is resting.

20. The device according to claim 19, wherein the at least one rod is flexible.

21. The device according to claim 19, wherein the at least one rod has a longitudinal contour matched to an inner contour of the container.

22. The device according to claim 19, wherein a leading end of the at least one rod is connected to a leading end of the balloon body by a string or a wire.

23. The device according to claim 14, wherein an outer surface of the balloon body has raised portions.

24. The device according to claim 23, wherein the raised portions are knob-shaped.

25. The device according to claim 14, wherein the expansion medium is a gas.

26. The device according to claim 14, wherein the expansion medium is air.

27. The device according to claim 14, wherein the expansion medium is a liquid.

28. The device according to claim 14, wherein the expansion medium is water.
